(19) United States
(12) Patent Application Publication
(10) Pub. No.: US 2016/0126603 A1
(43) Pub. Date: May 5, 2016

(54) HYBRID BUS BATTERY PACK COOLING STRUCTURE

(71) Applicant: Hyundai Motor Company, Seoul (KR)

(72) Inventor: Nam Seok Yun, Hwaseong (KR)

(21) Appl. No.: 14/678,934

(22) Filed: Apr. 4, 2015

(30) Foreign Application Priority Data
Oct. 31, 2014 (KR) 10-2014-0150069

(51) Int. Cl. H01M 10/625; H01M 10/6569; F28D 15/02; H01M 10/613

(52) U.S. Cl. CPC H01M 10/625; H01M 10/613; H01M 10/6569; F28D 15/02; H01M 2220/20

(57) ABSTRACT

A hybrid bus battery pack cooling structure is provided that includes a suction core that is installed between an evaporator and a compressor to inject a vaporized refrigerant to a battery pack mounted within a vehicle. Accordingly, a battery pack is cooled without using cool air to be supplied into the vehicle during warmer weather, and thus, the battery pack is cooled without loss of interior cooling performance.

### CROSS-REFERENCE TO RELATED APPLICATION

This application is based on and claims the benefit of priority to Korean Patent Application No. 10-2014-0150069, filed on Oct. 31, 2014 in the Korean Intellectual Property Office, the disclosure of which is incorporated herein in its entirety by reference.

### TECHNICAL FIELD

The present disclosure relates to a hybrid bus battery pack cooling structure, and more particularly, to a hybrid bus battery pack cooling structure for cooling a battery pack while driving a hybrid bus in warmer weather months.

### BACKGROUND

Environmentally-friendly vehicles such as an electric vehicle or a hybrid vehicle have batteries mounted therewithin to drive the vehicle motor. Typically in a hybrid bus vehicle, a battery back is cooled by installing a separate fan within an evaporator or transmitting cooled air supplied into the vehicle to the battery pack. In particular, cool air to be introduced into the vehicle is partially used to cool a battery, which corresponds to the reason for reduction in cooling performance in warmer weather months due to the increase in exterior temperature.

### SUMMARY

The present disclosure provides a hybrid bus battery pack cooling structure that ensures vehicle interior cooling performance and simultaneously and efficiently cool a battery pack in warmer weather months.

According to an exemplary embodiment of the present disclosure, a hybrid bus battery pack cooling structure may include a suction core installed between an evaporator and a compressor to inject a vaporized refrigerant to a battery pack mounted within a vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary view of a main part of a hybrid bus battery pack cooling structure according to an exemplary embodiment of the present disclosure;

FIG. 2 is an exemplary block diagram illustrating the flow of a refrigerant of the hybrid bus battery pack cooling structure of FIG. 1 according to an exemplary embodiment of the present disclosure; and

FIGS. 3A-3B are exemplary cross-sectional views the installed hybrid bus battery pack cooling structure of FIG. 1 according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the ” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the tem “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present disclosure will now be described in detail with reference to the accompanying drawings.

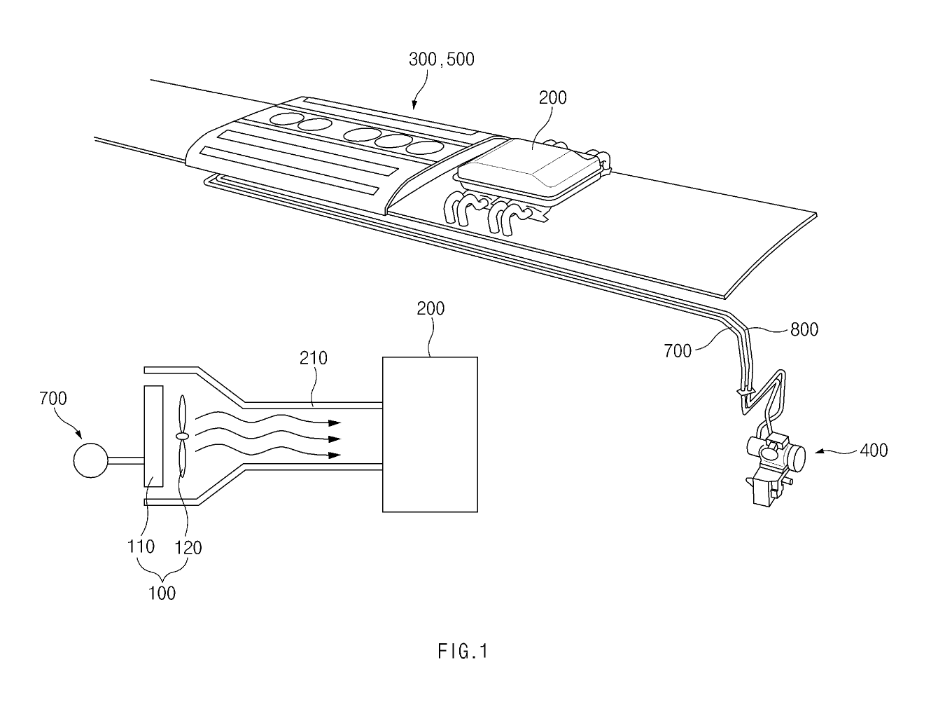

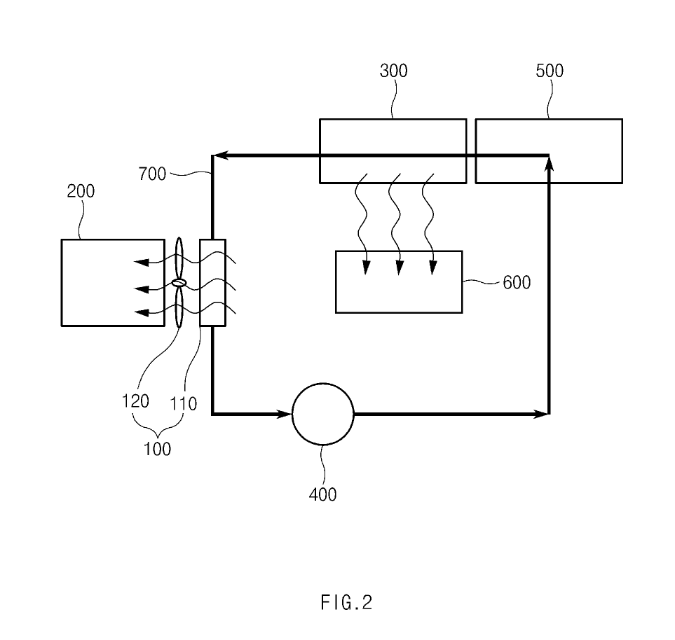

As illustrated in FIGS. 1 to 3B, a hybrid bus battery pack cooling structure according to the to present disclosure may include a suction core 100 installed between an evaporator 300 and a compressor 400 to inject a vaporized refrigerant into a battery pack 200 mounted within a vehicle.

The suction core 100 may include a chamber 110 configured to accommodate a vaporized refrigerant and a fan 120 to pressurize the vaporized refrigerant within the chamber 110 toward the battery pack 200. The capacity of the chamber 110, and the size and torque of the fan 120 may be determined based on an internal pressure of a suction pipe 700 and the size and heating value of the battery pack 200. The hybrid bus battery pack cooling structure may further include a suction pipe 700 disposed between the evaporator 300 and the compressor 400 to allow the vaporized refrigerant to flow in the suction pipe 700. The suction core 100 may be formed within the suction pipe 700.

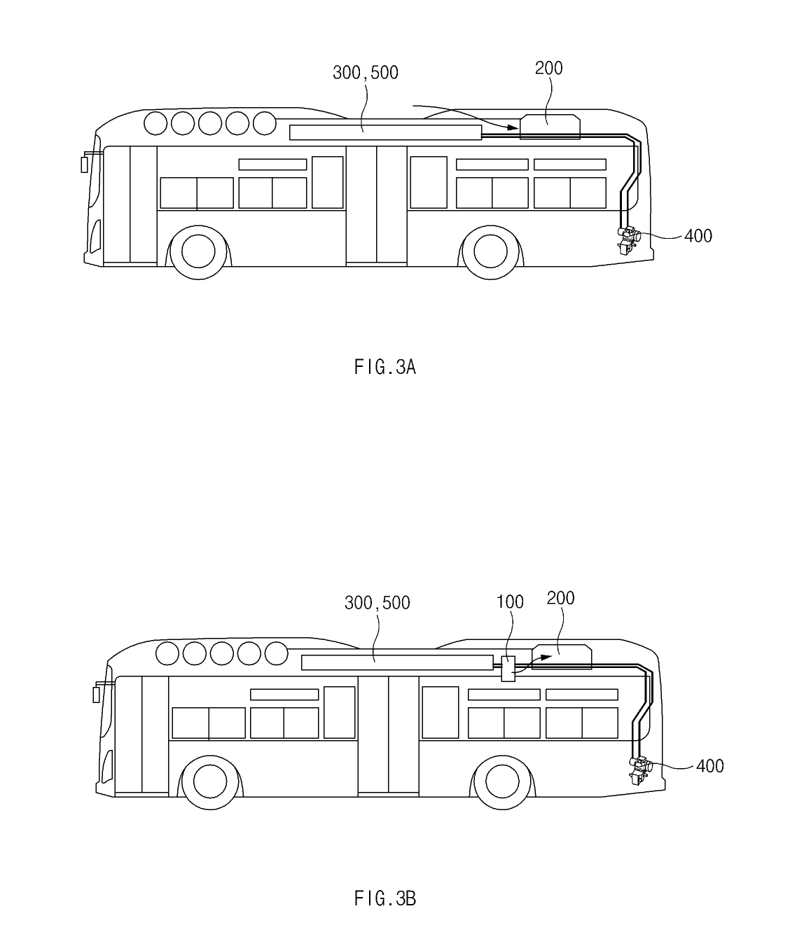

The battery pack 200 may include a suction hose 210 connected to an internal portion of the battery pack 200 and connected to the suction core 100 to receive the vaporized refrigerant from the suction core 100. In addition, the battery pack 200 may include a discharge hose used to connect the battery pack 200 and the suction pipe 700 to discharge the vaporized refrigerant from the battery pack 200. When an air conditioner is not driven or operated, the battery pack 200 may include a duct opened and closed to an exterior of the vehicle to cool the battery pack 200 using outdoor air (refer to FIG. 3A). That is, the duct may be in communication with the exterior of the vehicle and may be configured to suction air from outside of the vehicle and discharge air to the outside of the vehicle. The air suctioned from the outside of the vehicle through the duct may then be used to cool the battery pack 200.

Furthermore, the evaporator 300 may include a condenser 500 connected to the evaporator 300 through a discharge pipe 800 to liquefy the vaporized refrigerant compressed through the compressor 400. Additionally, the evaporator 300 may be configured to evaporate the refrigerant liquefied through the condenser 500 to generate evaporation latent heat, and cool surrounding air. The evaporator 300 may include an air conditioning duct 600 configured to guide surrounding air cooled through evaporation latent heat into the vehicle.

The above configured hybrid bus battery pack cooling structure using an air conditioning pipe according to an exemplary embodiment of the present disclosure may include the evaporator 300, the battery pack 200, and the suction core 100 installed on a vehicle roof. In addition, since the vaporized refrigerant may be injected into the battery pack 200 using the fan 120 included in the suction core 100, cool air to be used for interior cooling may not be used for battery cooling, thereby preventing reduction in interior cooling performance

When the above hybrid bus battery pack cooling structure according to the present disclosure is used, a battery pack may be cooled without using cool air to be supplied into the vehicle during warmer months (e.g., summer weather), and thus, the battery pack may be cooled without loss of interior cooling performance. In other words, the exterior air suctioned into the vehicle may be used to cool the interior of the vehicle instead of merely being used to cool the battery pack, to improve interior cooling performance when the exterior temperature is greater than a particular temperature.

While the present disclosure has been particularly shown and described with reference to exemplary embodiments and drawings thereof, it will be understood by those of ordinary skill in the art that various changes in form and details may be made therein without departing from the spirit of the present invention as defined by the following claims.

What is claimed is:

1. A hybrid bus battery pack cooling structure, comprising:
a suction core installed between an evaporator and a compressor to inject a vaporized refrigerant to a battery pack mounted within a vehicle.

2. The hybrid bus battery pack cooling structure according to 1, wherein the suction core includes:
a chamber configured to accommodate the vaporized refrigerant; and
a fan configured to pressurize the vaporized refrigerant within the chamber toward the battery pack.

3. The hybrid bus battery pack cooling structure according to claim 1, further comprising:
a suction pipe disposed between the evaporator and the compressor to allow the vaporized refrigerant to flow in the suction pipe, wherein the suction core is formed within the suction pipe.

4. The hybrid bus battery pack cooling structure according to claim 1, wherein the battery pack includes a suction hose connected to an internal portion of the battery pack and connected to the suction core to receive the vaporized refrigerant from the suction core.

5. The hybrid bus battery pack cooling structure according to claim 1, wherein the evaporator includes a condenser connected to the evaporator.

6. The hybrid bus battery pack cooling structure according to claim 5, wherein the condenser is connected to the compressor through a discharge pipe to liquefy the vaporized refrigerant compressed through the compressor.

7. The hybrid bus battery pack cooling structure according to claim 5, wherein the evaporator is configured to evaporate a refrigerant liquefied through the condenser to generate evaporation latent heat and cool surrounding air.

8. The hybrid bus battery pack cooling structure according to claim 7, wherein the evaporator includes an air conditioning duct configured to guide the surrounding air cooled through the evaporation latent heat into the vehicle.

9. A hybrid bus battery pack cooling structure, comprising:
an air conditioning system that includes:
an evaporator installed within a vehicle and configured to evaporate refrigerant to generate a vaporized refrigerant;
a compressor configured to compress the vaporized refrigerant; and
a suction pipe in which the vaporized refrigerant flows and that connects the evaporator and the compressor; and
a suction core connected to a suction hose connected to an internal portion of a battery pack mounted within the vehicle, and installed within the suction pipe to inject the vaporized refrigerant into the suction hose.

10. The hybrid bus battery pack cooling structure according to claim 9, wherein the evaporator, the battery pack, and suction core are installed on a vehicle roof.

11. The hybrid bus battery pack cooling structure according to claim 9, wherein the battery pack includes a discharge hose configured to connect the battery pack and the suction pipe to discharge the vaporized refrigerant from the battery pack.
